(19) United States
(12) Patent Application Publication
(10) Pub. No.: US 2011/0160400 A1
(43) Pub. Date: Jun. 30, 2011

(54) Phosphoric and Acrylic Copolymer Resin Having Excellent Transparency and Flame Retardancy and Resin Composition Including the Same

(75) Inventors: Jin Seong LEE, Uiwang-si (KR); Yong Hee KANG, Uiwang-si (KR); Kee Hae KWON, Uiwang-si (KR); Man Suk KIM, Uiwang-si (KR); Jong Tae YOON, Uiwang-si (KR); Jung Hun LEE, Uiwang-si (KR); Jin Hwa CHUNG, Uiwang-si (KR)

(73) Assignee: CHEIL INDUSTRIES INC., Gumi-si (KR)

(21) Appl. No.: 12/966,133

(22) Filed: Dec. 13, 2010

(30) Foreign Application Priority Data
Dec. 30, 2009 (KR) 10-2009-0134557

(51) Int. Cl. C08L 51/00; C08F 30/02

(52) U.S. Cl. 525/64; 526/278

(57) ABSTRACT

The present invention provides a phosphoric and acrylic copolymer resin that can have good transparency, scratch resistance and flame retardancy and a composition including the same. The phosphoric and acrylic copolymer resin includes repeat units of (A-1) at least one vinyl monomer and (A-2) at least one phosphoric monomer.

### CROSS-REFERENCE TO RELATED APPLICATION

This application claims priority from Korean Patent Application No. 2009-0134557, filed in the Korean Intellectual Property Office on Dec. 30, 2009, the entire disclosure of which is incorporated herein by reference.

### FIELD OF THE INVENTION

The present invention relates to a phosphoric and acrylic copolymer resin that can have excellent transparency and flame retardancy and a resin composition including the same.

### BACKGROUND OF THE INVENTION

Generally, thermoplastic resins have lower specific gravity than glasses and metals and have good physical properties such as moldability and impact resistance. Recently, plastic products have rapidly replaced conventional glass or metal products and have been widely used in various products, from electrical and electronic goods to auto parts, as large, light-weight, and economical products are becoming a widespread trend. In addition, the appearance and function of the plastic products have become important when used in housings of electrical and electronic goods and auto parts. Accordingly, there is a need for plastic materials which can provide exterior scratch resistance, impact resistance, and flame retardancy.

Conventionally, a hard coating method has been used to improve the scratch resistance of plastic products. The hard coating method includes coating a surface of an injection-molded resin with an organic-inorganic hybrid material and curing the organic-inorganic hybrid material on the surface of the resin using heat or ultra violet light. However, this method requires an additional coating process which can increase processing time and manufacturing costs and may also cause environmental problems.

Recently, with increased interest in protecting the environment and in reducing manufacturing costs, there has been a move away from the hard coating method. Thus, there is a need for a non-coated resin which has good scratch resistance. Also, it is important to develop a resin with good scratch resistance for the housing manufacturing industry.

Moreover, there is an increased need for a resin which has good transparency, as well as flame retardancy and scratch resistance, so that the resin can have good colorability and permit the use of design elements such as gradient color.

Polycarbonate resins including a flame retardant can provide products having good transparency and flame retardancy. However, such products can have low scratch resistance, as exhibited by a low pencil hardness of HB to F.

Products including an acrylic resin such as polymethyl methacrylate (PMMA) can have good transparency and scratch resistance. However, such products typically do not have good flame retardancy. Even if a phosphoric flame retardant is added to the PMMA resin, the resin can achieve a flame retardant rating only of V1 or higher. Further, the inventors are not aware of any reported transparent acrylic resin, which itself inherently has good flame retardancy without the addition of a separate flame retardant agent.

### SUMMARY OF THE INVENTION

The present invention provides a phosphoric and acrylic copolymer resin that can have excellent flame retardancy and a resin composition including the same.

The present invention further provides a phosphoric and acrylic copolymer resin that can have excellent scratch resistant and a resin composition including the same.

The present invention further provides a phosphoric and acrylic copolymer resin that can have excellent impact strength and a resin composition including the same.

The present invention further provides a phosphoric and acrylic copolymer resin that can have excellent flame retardancy, scratch resistance, impact strength and transparency at the same time and a resin composition including the same.

The phosphoric and acrylic copolymer of the invention can be prepared by copolymerizing a vinyl monomer and a phosphoric monomer.

In exemplary embodiments, the present invention provides a phosphoric and acrylic copolymer resin comprising repeat units derived from (A-1) at least one vinyl monomer represented by the following Chemical Formula 1 and repeat units derived from (A-2) at least one phosphoric monomer represented by the following Chemical Formula 2.

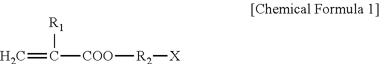

wherein R₁ is H or (CH₂)n-CH₃, wherein n is an integer from 0 to 5;

R₂ is (CH₂)ₘ, wherein m is an integer from 0 to 10; and

X includes a methyl group, a cyclohexyl group, a phenyl group, a methylphenyl group, a methylethylphenyl group, a propylphenyl group, a methoxyphenyl group, a cyclohexylphenyl group, a chlorophenyl group, a bromophenyl group, a phenylphenyl group, or a benzylphenyl group.

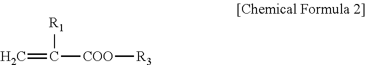

wherein R₁ is H or (CH₂)n-CH₃, wherein n is an integer from 0 to 5; and

R₃ is a substituent represented by the following Chemical Formula 3.

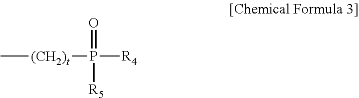

wherein t is an integer from 1 to 10; and

R₄ and R₅ are independently —O(CH₂)qX, wherein q is an integer from 0 to 5 and X includes a methyl group, a cyclohexyl group, a phenyl group, a methylphenyl group, a methylethylphenyl group, a propylphenyl group, a methoxyphenyl group, a cyclohexylphenyl group, a chlorophenyl group, a bromophenyl group, a phenylphenyl group, or a benzylphenyl group.

In an exemplary embodiment of the present invention, the phosphoric and acrylic copolymer resin comprises (A-1) about 30 to about 85% by weight of the vinyl monomer and (A-2) about 15 to about 70% by weight of the phosphoric monomer.

In another exemplary embodiment of the present invention, the phosphoric and acrylic copolymer resin has a weight average molecular weight of about 30 to about 150 Kg/mol.

In another exemplary embodiment of the present invention, the phosphoric and acrylic copolymer resin includes phosphorus in an amount of about 2.0 to about 7.0% by weight.

In another exemplary embodiment of the present invention, the phosphoric and acrylic copolymer resin has a flame retardancy of V2 to V0 measured in accordance with UL-94 at a thickness of ⅛″.

In another exemplary embodiment of the present invention, the phosphoric and acrylic copolymer resin has a total luminous transmittance of 85% or more measured in accordance with ASTM D1003 at a thickness of 2.5 mm.

In another exemplary embodiment of the present invention, the phosphoric and acrylic copolymer resin has a pencil hardness of HB to 2H measured in accordance with JIS K5401.

In another exemplary embodiment of the present invention, the phosphoric and acrylic copolymer resin is prepared by suspension polymerization.

In another exemplary embodiment, the present invention provides a flameproof acrylic resin composition comprising (A) about 100 parts by weight of the phosphoric and acrylic copolymer resin and (B) about 1 to about 30 parts by weight of a transparent and soft acrylate resin, wherein (B) the transparent and soft acrylate resin is prepared by grafting a vinyl monomer into an acrylic rubber core.

In another exemplary embodiment of the present invention, (B) the transparent and soft acrylate resin has a refractive index of about 1.485 to about 1.495.

In another exemplary embodiment of the present invention, the flameproof acrylic resin composition has an unnotched izod impact strength of 20 kgfcm/cm or more measured in accordance with ASTM D256 at a thickness of ¼′.

In another exemplary embodiment of the present invention, the flameproof acrylic resin composition further comprises (C) about 1 to about 30 parts by weight of a phosphoric flame retardant.

In another exemplary embodiment of the present invention, the flameproof acrylic resin composition has a flame retardancy of V1 to V0 measured in accordance with UL94 at a thickness of ⅛″.

In another exemplary embodiment of the present invention, the flameproof acrylic resin composition further comprises at least one or more additives selected from the group consisting of anti-dripping agents, impact modifiers, antioxidants, plasticizers, thermal stabilizers, light stabilizers, compatibilizers, pigments, dyes, inorganic fillers, antimicrobials and antistatic agents.

In another exemplary embodiment, the present invention provides plastic molded articles prepared using the flameproof acrylic resin composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Phosphoric and Acrylic Copolymer Resin

The present invention provides a phosphoric and acrylic copolymer resin comprising repeat units derived from (A-1) at least one vinyl monomer represented by the following Chemical Formula 1 and repeat units derived from (A-2) at least one phosphoric monomer represented by the following Chemical Formula 2.

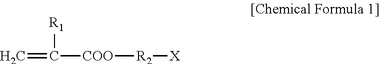

wherein R₁ is H or (CH₂)n-CH₃, wherein n is an integer from 0 to 5;

R₂ is (CH₂)ₘ, wherein m is an integer from 0 to 10; and

X includes a methyl group, a cyclohexyl group, a phenyl group, a methylphenyl group, a methylethylphenyl group, a propylphenyl group, a methoxyphenyl group, a cyclohexylphenyl group, a chlorophenyl group, a bromophenyl group, a phenylphenyl group, or a benzylphenyl group.

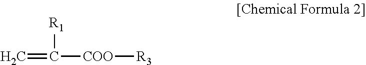

wherein R₁ is H or (CH₂)n-CH₃, wherein n is an integer from 0 to 5; and

R₃ is a substituent represented by the following Chemical Formula 3.

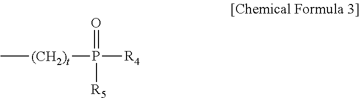

wherein t is an integer from 1 to 10; and

R₄ and R₅ are independently —O(CH₂)qX, wherein q is an integer from 0 to 5 and X includes a methyl group, a cyclohexyl group, a phenyl group, a methylphenyl group, a methylethylphenyl group, a propylphenyl group, a methoxyphenyl group, a cyclohexylphenyl group, a chlorophenyl group, a bromophenyl group, a phenylphenyl group, or a benzylphenyl group.

Examples of (A-1) the vinyl monomer may include, but are not limited to, methyl methacrylate, ethyl methacrylate, propyl methacrylate, methyl acrylate, ethyl acrylate, propyl acrylate, cyclohexyl methacrylate, phenyl methacrylate, and the like, and combinations thereof.

Examples of (A-2) the phosphoric monomer may include, but are not limited to, dimethyl (methacryloyloxymethyl) phosphonate, diethyl (methacryloyloxymethyl) phosphonate, dimethyl (acryloyloxymethyl) phosphonate, diethyl (acryloyloxymethyl), phosphonate, methylethyl (methacryloyloxymethyl) phosphonate, methylethyl (acryloyloxymethyl) phosphonate, dimethyl (methacryloyloxyethyl) phosphonate, diethyl (methacryloyloxyethyl) phosphonate, dipropyl (methacryloyloxyethyl) phosphonate, and the like, and combinations thereof.

In an exemplary embodiment of the present invention, the phosphoric and acrylic copolymer resin comprises (A-1) about 30 to about 85% by weight of the vinyl monomer and (A-2) about 15 to about 70% by weight of the phosphoric monomer.

In some embodiments, the phosphoric and acrylic copolymer resin can include the (A-1) vinyl monomer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85% by weight. Further, according to some embodiments of the present invention, the amount of the (A-1) vinyl monomer can be in a range from about any of the foregoing amounts to about any other of the foregoing amounts.

In some embodiments, the phosphoric and acrylic copolymer resin can include the (A-2) phosphoric monomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70% by weight. Further, according to some embodiments of the present invention, the amount of the (A-2) phosphoric monomer can be in a range from about any of the foregoing amounts to about any other of the foregoing amounts.

The phosphoric and acrylic copolymer resin (A) can be prepared by methods such as emulsion polymerization, suspension polymerization, solution polymerization, bulk polymerization, and the like. In an exemplary embodiment of the present invention, the phosphoric and acrylic copolymer resin (A) can be prepared by suspension polymerizing (A-1) about 30 to about 85% by weight of the vinyl monomer and (A-2) about 15 to about 70% by weight of the phosphoric monomer.

In exemplary embodiments of the present invention, the phosphoric and acrylic copolymer resin can have a weight average molecular weight of about 30 to about 150 Kg/mol, for example about 50 to about 120 Kg/mol. In some embodiments, the weight average molecular weight of the phosphoric and acrylic copolymer resin can be about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150 Kg/mol. Further, according to some embodiments of the present invention, the weight average molecular weight of the phosphoric and acrylic copolymer resin can be in a range from about any of the foregoing amounts to about any other of the foregoing amounts. In the present invention, if the weight average molecular weight of the phosphoric and acrylic copolymer resin is less than about 30 Kg/mol, the properties of the present invention may be deteriorated, and the flame retardancy may be deteriorated because the drip phenomenon can occur.

In exemplary embodiments of the present invention, the phosphoric and acrylic copolymer resin can include phosphorous in an amount of about 2.0 to about 7.0% by weight. In some embodiments, the phosphoric and acrylic copolymer resin can include phosphorous in an amount of about 2.0, 3.0, 4.0, 5.0, 6.0, or 7.0% by weight. Further, according to some embodiments of the present invention, the amount of phosphorous can be in a range from about any of the foregoing amounts to about any other of the foregoing amounts.

In the present invention, if the amount of phosphorus is less than about 2.0% by weight, the flame retardancy assessment of UL94 may not be satisfied, and if the amount of phosphorus is greater than about 7.0% by weight, it can be difficult to polymerize the phosphoric and acrylic copolymer resin and thermostability may be deteriorated.

In exemplary embodiments of the present invention, the phosphoric and acrylic copolymer resin can have a total luminous transmittance measured in accordance with ASTM D1003 at a thickness of 2.5 mm of 85% or higher, and the phosphoric and acrylic copolymer resin can have a flame retardancy of V2; V1 or V0 measured in accordance with UL-94 at a thickness of ⅛″. In the present invention, even when the phosphoric and acrylic copolymer resin has a weight molecular weight lower than 30,000 g/mol, the resin can still have a flame retardancy rating of V2. According to the UL94 method for measuring flame retardancy, if the flame retardancy rating is more than the V2 level, the flame retardancy may be acceptable. Accordingly, the phosphoric and acrylic copolymer resin according to the present invention can be acceptable as a transparent and flameproof resin. Also, the phosphoric and acrylic copolymer resin can also have excellent scratch resistance, for example, a pencil hardness of MB to 2H measured in accordance with JIS K5401.

Flameproof Acrylic Resin Composition

In exemplary embodiments of the present invention, the flameproof acrylic resin composition comprises (A) about 100 parts by weight of the phosphoric and acrylic copolymer resin and (B) about 1 to about 30 parts by weight of a transparent and soft acrylate resin.

In exemplary embodiments of the present invention, the flameproof acrylic resin composition further comprises (C) about 1 to about 30 parts by weight of a phosphoric flame retardant.

(A) Phosphoric and Acrylic Copolymer Resin

The phosphoric and acrylic copolymer resin used in the flameproof acrylic resin composition of the present invention has already been described in detail above.

(B) Transparent and Soft Acrylate Resin

In exemplary embodiments of the present invention, the transparent and soft acrylate resin is prepared by grafting a vinyl monomer on an acrylic rubber core, and the transparent and soft acrylate resin is added for the purpose of enhancing impact strength. If (B) the transparent and soft acrylate resin is added into (A) the phosphoric and acrylic copolymer resin having transparency, flame retardancy, scratch resistance and so forth, transparency may be slightly deteriorated, but impact resistance can be significantly increased. In exemplary embodiments, the flameproof acrylic resin composition of the present invention including (B) the transparent and soft acrylate resin may have an unnotched izod impact strength of 20 kgfcm/cm or more measured in accordance with ASTM D256 at a thickness of ¼″.

As used herein, reference to a “soft” acrylate resin refers to an acrylate resin including an acrylic rubber core as defined herein. Reference to a “soft” acrylate resin as used herein may also refer to the core-shell graft copolymer having a rubber core and a vinyl monomer derived shell with a surface hardness of 70 Shore D or less, measured in accordance with ASTM D2240.

In exemplary embodiments of the present invention, the refractive index of (B) the transparent and soft acrylate resin is about 1.485 to about 1.495. In some embodiments, the refractive index of (B) the transparent and soft acrylate resin can be about 1.485, 1.486, 1.487, 1.488, 1.489, 1.490, 1.491, 1.492, 1.493, 1.494, or 1.495. Further, according to some embodiments of the present invention, the refractive index of (B) the transparent and soft acrylate resin can be in a range from about any of the foregoing amounts to about any other of the foregoing amounts. As used herein, reference to a “transparent” acrylate resin refers to an acrylate resin having a refractive index as set forth herein.

When (B) the transparent and soft acrylate resin has a refractive index within the above range, it can ensure the transparency of the flameproof acrylic resin composition. Otherwise, if there is a significant difference between the refractive index of (A) the phosphoric and acrylic copolymer resin and (B) the transparent and soft acrylate resin in the flameproof acrylic resin composition, the haze of the composition can increase, which can deteriorate the transparency of the flameproof acrylic resin composition.

The transparent and soft acrylate resin can include about 60 to about 80% by weight of the acrylic rubber core and about 20 to about 40% by weight of the vinyl monomer. The particle size of the acrylic rubber is not limited and in exemplary embodiments can range from about 0.1 to about 4 μm. Exemplary acrylic rubbers for the acrylic rubber core can include without limitation C1-C10 alkyl acrylate rubbers, such as butyl acrylate rubber.

The transparent and soft acrylate resin includes one or more vinyl monomers grafted onto the acrylic rubber core. Exemplary vinyl monomers include without limitation aromatic vinyl compounds, C₁-C₈(meth)acrylic acid alkyl ester compounds, vinyl cyanide compounds, maleic anhydride, C₁ to C₄ alkyl- or phenyl N-substituted maleimide, and the like, and combinations thereof. Examples of the aromatic vinyl compound may include, but are not limited to, styrene, α-methyl styrene, β-methyl styrene, p-methyl styrene, p-t-butylstyrene, ethylstyrene, vinyl xylene, monochlorostyrene, dichlorostyrene, dibromostyrene, vinyl naphthalene and the like, and combinations thereof. Examples of the C₁-C₈ (meth)acrylic acid alkyl ester compounds may include, but are not limited to, methacrylic acid alkyl ester monomers such as methyl methacrylate, ethyl methacrylate, propyl methacrylate, and butyl methacrylate; acrylic acid alkyl ester monomers such as methyl acrylate, ethyl acrylate, propyl acrylate, acrylate, and 2-ethyl hexyl acrylate; and the like, and combinations thereof. Examples of the vinyl cyanide compounds may include, but are not limited to, acrylonitrile, ethacrylonitrile and methacrylonitrile, and the like, and combinations thereof. In exemplary embodiments, the vinyl monomer can include styrene, methyl methacrylate, or a combination thereof.

In exemplary embodiments of the present invention, the flameproof acrylic resin composition of the invention can include (B) the transparent and soft acrylate resin in an amount of about 1 to about 30 parts by weight, based on about 100 parts by weight of (A) the phosphoric and acrylic copolymer resin. In some embodiments, the flameproof acrylic resin composition of the invention can include (B) the transparent and soft acrylate resin in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of (B) the transparent and soft acrylate resin can be in a range from about any of the foregoing amounts to about any other of the foregoing amounts.

If the amount of the transparent and soft acrylate resin is more than about 30 parts by weight, haze can increase and flame retardancy and scratch resistance can deteriorate.

(C) Phosphoric flame retardant In the present invention, the flameproof acrylic resin composition can further comprise (C) about 1 to about 30 parts by weight of a phosphoric flame retardant, based on about 100 parts by weight of (A) the phosphoric and acrylic copolymer resin. In some embodiments, the flameproof acrylic resin composition of the invention can include (C) the phosphoric flame retardant in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of (C) the phosphoric flame retardant can be in a range from about any of the foregoing

Examples of the phosphoric flame retardant may include, but are not limited to, red phosphorus, phosphonate, phosphinate, and the like, and combinations thereof.

In exemplary embodiments of the present invention, the phosphoric flame retardant may be a compound, or combination of compounds, represented by the following Chemical Formula 4.

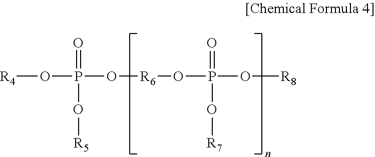

wherein R₄, R₅, R₇ and R₈ are independently C₆-C₂₀ aryl or C₁-C₁₀ alkyl substituted C₆-C₂₀ aryl;

R₆ is a derivative of a dialcohol such as resorcinol, hydroquinol, bisphenol-A, or bisphenol-S; and

n is an integer from 0 to 10.

When n is 0, examples of the phosphoric flame retardant may include, but are not limited to, triphenyl phosphate, tricresyl phosphate, cresyl diphenyl phosphate, trixylyl phosphate, tri(2,4,6-trimethyl phenyl) phosphate, tri(2,4-di-tert-butyl phenyl) phosphate, tri(2,6-di-tert-butyl phenyl) phosphate, and the like, and combinations thereof.

When n is 1, examples of the phosphoric flame retardant may include, but are not limited to, resorcinol bis(diphenyl phosphate), hydroquinol bis(diphenyl phosphate), bisphenol-A bis(diphenyl phosphate), resorcinol bis(2,6-di-tert-butyl phenyl phosphate), hydroquinol bis(2,6-dimethyl phenyl phosphate), and the like, and combinations thereof.

When n is 2 or higher, the phosphoric flame retardant may exist as a mixture in the form of an oligomer.

In exemplary embodiments of the present invention, the phosphoric flame retardant may be a compound represented by the following Chemical Formula 5.

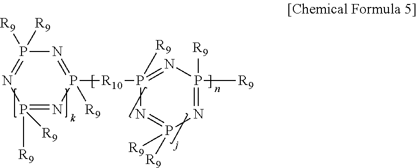

wherein each R₉ is independently C₁-C₁₀ alkyl, C₆-C₂₀ aryl, C₁-C₁₀ alkyl substituted C₆-C₂₀ aryl, C₇-C₂₀ aralkyl, C₁-C₁₀ alkoxy, C₇-C₂₀ aryloxy, amino or hydroxyl;

k and j are independently an integer from 0 to 10; and

n is a number average degree of polymerization, wherein the average value of n is about 0.3 to about 3.

The flameproof acrylic resin composition according to the present invention can have a total luminous transmittance of 85% or more measured in accordance with ASTM D1003 at a thickness of 2.5 mm, an unnotched izod impact strength of 20 kgfcm/cm or more measured in accordance with ASTM D256 at a thickness of ¼″, and a pencil hardness of HB to 2H measured in accordance with JIS K5401. When (C) the phosphoric flame retardant is added, a flame retardancy of V1 to V0 may be achieved.

Depending on its use, the flameproof acrylic resin composition may further comprise at least one or more additives selected from the group consisting of anti-dripping agents, impact modifiers, antioxidants, plasticizers, thermal stabilizers, light stabilizers, compatibilizers, pigments, dyes, inorganic fillers, antimicrobials, and antistatic agents. These additives may be used alone or in combination with one another and may be used in conventional amounts.

Molded Articles Manufactured from Flameproof Acrylic Resin Composition

The present invention provides molded articles manufactured from the flameproof acrylic resin composition. Since the flameproof acrylic resin composition can have excellent scratch resistance, impact strength, transparency, and flame retardancy, the flameproof acrylic resin composition may be molded into various articles such as housings and parts for electrical and electronic goods, auto parts, lens, windows and the like.

In exemplary embodiments, the flameproof acrylic resin composition may be molded into articles such as housings for TVs, audio sets, washing machines, cassette players, MP3 players, telephones, game devices, video players, computers, photocopiers, and the like, and exterior and interior materials for automobile such as car dashboards, instrument panels, door panels, quarter panels, wheel covers, and the like.

The molding methods may be, but are not limited to, extrusion, injection, or casting molding, and may be easily carried out by a person with ordinary skill in the art.

The invention may be better understood by reference to the following examples which are intended for the purpose of illustration and are not to be construed as in any way limiting the scope of the present invention, which is defined in the claims appended hereto.

### EXAMPLES

The particulars of the components used in the Examples and Comparative Examples are as follows:

(A 1-1): A phosphoric and acrylic copolymer is prepared by suspension polymerization of 75% by weight of methyl methacrylate and 25% by weight of diethyl (acryloyloxy methyl) phosphonate, wherein the weight average molecular weight of the phosphoric and acrylic copolymer is 40,000, and the amount of phosphorus in the phosphoric and acrylic copolymer resin is 3.4% by weight.

(A 1-2): A phosphoric and acrylic copolymer is prepared by suspension polymerization of 75% by weight of methyl methacrylate and 25% by weight of diethyl (methacryloyloxy ethyl) phosphonate, wherein the weight average molecular weight of the phosphoric and acrylic copolymer is 70,000, and the amount of phosphorus in the phosphoric and acrylic copolymer resin is 3.0% by weight.

(A 1-3): A phosphoric and acrylic copolymer is prepared by suspension polymerization of 60% by weight of methyl methacrylate and 40% by weight of diethyl (acryloyloxy ethyl) phosphonate, wherein the weight average molecular weight of the phosphoric and acrylic copolymer is 80,000; and the amount of phosphorus in the phosphoric and acrylic copolymer resin is 5.1% by weight.

(A 1-4): A phosphoric and acrylic copolymer is prepared by suspension polymerization of 65% by weight of methyl methacrylate and 35% by weight of dipropyl (methacryloyloxy methyl) phosphonate, wherein the weight average molecular weight of the phosphoric and acrylic copolymer is 100,000, and the amount of phosphorus in the phosphoric and acrylic copolymer resin is 4.0% by weight.

(A 1-5): A phosphoric and acrylic copolymer is prepared by suspension polymerization of 70% by weight of methyl methacrylate and 30% by weight of diethyl (methacryloyloxy methyl) phosphonate, wherein the weight average molecular weight of the phosphoric and acrylic copolymer is 100,000, and the amount of phosphorus in the phosphoric and acrylic copolymer resin is 3.8% by weight.

(A 1-6): A phosphoric and acrylic copolymer is prepared by suspension polymerization of 70% by weight of methyl methacrylate and 30% by weight of dimethyl (methacryloyloxy methyl) phosphonate, wherein the weight average molecular weight of the phosphoric and acrylic copolymer is 100,000, and the amount of phosphorus in the phosphoric and acrylic copolymer resin is 4.4% by weight.

(A 1-7): A phosphoric and acrylic copolymer is prepared by suspension polymerization of 60% by weight of methyl methacrylate and 40% by weight of ethylmethyl (methacryloyloxy methyl) phosphonate, wherein the weight average molecular weight of the phosphoric and acrylic copolymer is 100,000, and the amount of phosphorus in the phosphoric and acrylic copolymer resin is 5.4% by weight.

(A 1-8): A phosphoric and acrylic copolymer is prepared by suspension polymerization of 65% by weight of methyl methacrylate, 10% by weight of methyl acrylate and 25% by weight of dimethyl (methacryloyloxy methyl) phosphonate, wherein the weight average molecular weight of the phosphoric and acrylic copolymer is 40,000, and the amount of phosphorus in the phosphoric and acrylic copolymer resin is 3.6% by weight.

(A 1-9): A phosphoric and acrylic copolymer is prepared by suspension polymerization of 65% by weight of methyl methacrylate, 10% by weight of methyl acrylate and 25% by weight of diethyl (acryloyloxy ethyl) phosphonate, wherein the weight average molecular weight of the phosphoric and acrylic copolymer is 40,000, and the amount of phosphorus in the phosphoric and acrylic copolymer resin is 3.2% by weight.

(A 1-10): A phosphoric and acrylic copolymer is prepared by suspension polymerization of 55% by weight of methyl methacrylate, 10% by weight of methyl acrylate, 10% by weight of diethyl (methacryloyloxy methyl) phosphonate and 25% by weight of dimethyl (methacryloyloxy methyl) phosphonate, wherein the weight average molecular weight of the phosphoric and acrylic copolymer is 100,000, and the amount of phosphorus in the phosphoric and acrylic copolymer resin is 4.9% by weight.

(A 2-1): A phosphoric and acrylic copolymer is prepared by suspension polymerization of 87% by weight of methyl methacrylate and 13% by weight of diethyl (acryloyloxy methyl) phosphonate, wherein the weight average molecular weight of the phosphoric and acrylic copolymer is 40,000, and the amount of phosphorus in the phosphoric and acrylic copolymer resin is 1.8% by weight.

(A 2-2): A phosphoric and acrylic copolymer is prepared by suspension polymerization of 88% by weight of methyl methacrylate and 12% by weight of diethyl (methacryloyloxy ethyl) phosphonate, wherein the weight average molecular weight of the phosphoric and acrylic copolymer is 70,000, and the amount of phosphorus in the phosphoric and acrylic copolymer resin is 1.4% by weight.

(A 2-3): A phosphoric and acrylic copolymer is prepared by suspension polymerization of 87% by weight of methyl methacrylate and 13% by weight of diethyl (acryloyloxy ethyl) phosphonate, wherein the weight average molecular weight of the phosphoric and acrylic copolymer is 80,000, and the amount of phosphorus in the phosphoric and acrylic copolymer resin is 1.7% by weight.

(A 2-4): A phosphoric and acrylic copolymer is prepared by suspension polymerization of 88% by weight of methyl methacrylate and 12% by weight of dipropyl (methacryloyloxy methyl) phosphonate, wherein the weight average molecular weight of the phosphoric and acrylic copolymer is 100,000, and the amount of phosphorus in the phosphoric and acrylic copolymer resin is 1.4% by weight.

(A 2-5): A phosphoric and acrylic copolymer is prepared by suspension polymerization of 78% by weight of methyl methacrylate, 10% by weight of methyl acrylate and 12% by weight of diethyl (acryloyloxy ethyl) phosphonate, wherein the weight average molecular weight of the phosphoric and acrylic copolymer is 70,000, and the amount of phosphorus in the phosphoric and acrylic copolymer resin is 1.5% by weight.

(B): Transparent and soft acrylate resin including a core of butyl acrylate and a shell of methyl methacrylate (MMA) and styrene is employed, wherein the glass transition temperature of the transparent and soft acrylate resin is from 15 to 30° C., the size of the same is 0.2±0.1 μm, and the surface hardness of the same is less than 70 Shore D, measured in accordance with ASTM D2240, and the total luminous transmittance is more than 88% (3 mm).

(C): Resorcinol bis(diphenyl phosphate) is employed as a flame retardant.

### Examples 1-14 and Comparative Examples 1-7

The above-mentioned components in amounts set forth in the following Table 1 and Table 2 with antioxidant and thermal stabilizer are added to a conventional mixer and the mixture is extruded through a conventional twin screw extruder (L/D=35, (1)=45 mm) to prepare pellets. The prepared pellets are molded into test specimens for scratch resistance, flame retardancy, izod impact strength and transmittance in a 10 oz injection molding machine at about 200 to about 220° C. The prepared test specimens are kept for 48 hours at 23° C. and a relative humidity of 50%. The methods used for measuring each of the properties are as follows, and the measured results are shown in Table 1 and Table 2.

(1) Scratch resistance: the pencil hardness is measured in accordance with JIS K5401, using a flat specimen of 100×100 mm.

(2) Flame Retardancy: the flame retardancy is measured in accordance with UL 94, using a 1.8″ thick test specimen.

(3) Transmittance and Haze: the transmittance and haze is measured using a NDH 2000 Haze Meter produced by Nippon Denshoku Industries, which complies with ASTM D1003 standard, using a 2.5 mm thick test specimen, wherein the parameters used were calculated as follows:
Total luminous transmittance (%): (transmitted light from specimen)/(irradiated light into specimen)×100
HAZE (%): (distributed transmitted light)/(total luminous transmittance)×100

Higher total luminous transmittance or lower HAZE indicate better transparency.

(4) Impact strength: the unnotched izod impact strength is measured in accordance with ASTM D256, using a ¼″ thick test specimen.

TABLE 1

| | Examples | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| A 1-1 | 100 | | | | | | | | | | | | | |
| A 1-2 | | 100 | | | | | | | | | | | | |
| A 1-3 | | | 100 | | | | | | | | 100 | 100 | | |
| A 1-4 | | | | 100 | | | | | | | | | | |
| A 1-5 | | | | | 100 | | | | | | | | | 100 |
| A 1-6 | | | | | | 100 | | | | | | | | |
| A 1-7 | | | | | | | 100 | | | | | | 100 | |
| A 1-8 | | | | | | | | 100 | | | | | | |
| A 1-9 | | | | | | | | | 100 | | | | | |
| A 1-10 | | | | | | | | | | 100 | | | | |
| B | | | | | | | | | | | 10 | 15 | 15 | |
| C | | | | | | | | | | | | | 5 | 10 |
| Total Luminous | 89 | 89 | 90 | 89 | 90 | 89 | 88 | 89 | 88 | 89 | 87 | 86 | 86 | 89 |
| Transmittance (%) | | | | | | | | | | | | | | |
| HAZE (%) | 1.5 | 1.5 | 1.6 | 1.5 | 1.3 | 1.5 | 1.2 | 1.5 | 1.4 | 1.3 | 1.8 | 2.6 | 2.3 | 1.5 |
| Impact Strength | 4 | 9 | 7 | 7 | 7 | 7 | 7 | 4 | 4 | 8 | 23 | 32 | 21 | 2.5 |
| Flame Retardancy | V2 | V1 | V0 | V0 | V0 | V0 | V0 | V2 | V2 | V0 | V0 | V1 | V0 | V0 |
| Scratch Resistance | H | 2H | H | H | F | H | F | H | 2H | H | H | F | H | 2H |

TABLE 2

| | Comparative Examples | | | | | | |
|---|---|---|---|---|---|---|---|
| | 1 | 2 | 3 | 4 | 5 | 6 | 7 |
| A 2-1 | 100 | | | | | | |
| A 2-2 | | 100 | | | | | |
| A 2-3 | | | 100 | | | 100 | 100 |
| A 2-4 | | | | 100 | | | |
| A 2-5 | | | | | 100 | | |
| B | | | | | | 40 | 40 |
| C | | | | | | | 5 |
| Total Luminous | 89 | 90 | 90 | 89 | 88 | 65 | 67 |
| Transmittance | | | | | | | |
| (%) | | | | | | | |
| HAZE (%) | 1.2 | 1.2 | 1.2 | 1.3 | 1.4 | 13 | 13 |
| Impact Strength | 5 | 10 | 8 | 7 | 4 | 40 | 28 |
| Flame | Fail | Fail | Fail | Fail | Fail | Fail | Fail |
| Retardancy | | | | | | | |
| Scratch | 2H | 2H | 2H | 2H | 2H | HB | HB |
| Resistance | | | | | | | |

As shown above, Examples 1 to 10 prepared by employing (A) the phosphoric and acrylic copolymer resin show good transparency, flame retardancy and scratch resistance. Examples 11 and 12 show that when (B) the transparent and soft acrylate resin is added into (A) the phosphoric and acrylic copolymer resin, the transparency is slightly deteriorated, but the impact strength is much improved. Example 13 prepared by employing (C) the phosphoric flame retardant, as well as (A) the phosphoric and acrylic copolymer resin and (B) the transparent and soft acrylate resin shows good flame retardancy and scratch resistance, compared to Example 12. Examples 8 and 9 show that when the molecular weight of (A) the phosphoric and acrylic copolymer resin is lower, the flame retardancy is deteriorated due to dripping.

Comparative examples 1 to 3 prepared by employing poly methyl methacrylate (PMMA) show good transparency and scratch resistance, but do not show good flame retardancy. Comparative examples 2 and 4 show that when the amount of the phosphorus of (A) the phosphoric and acrylic copolymer resin is lower, the flame retardancy is deteriorated. Comparative examples 6 and 7 show that when the amounts of (A) the phosphoric and acrylic copolymer resin, (B) the transparent and soft acrylate resin and (C) the phosphoric flame retardant, respectively, are outside of the ranges in accordance with the present invention, the impact strength is improved, but the transparency, the flame retardancy and the scratch resistance is deteriorated.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A phosphoric and acrylic copolymer resin comprising repeat units derived from (A-1) at least one vinyl monomer represented by the following Chemical Formula 1 and repeat units derived from (A-2) at least one phosphoric monomer represented by the following Chemical Formula 2: 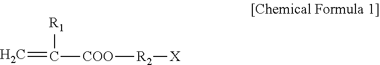
wherein R₁ is H or (CH₂)n-CH₃, wherein n is an integer from 0 to 5;
R₂ is (CH₂)ₘ, wherein m is an integer from 0 to 10; and
X includes a methyl group, a cyclohexyl group, a phenyl group, a methylphenyl group, a methylethylphenyl group, a propylphenyl group, a methoxyphenyl group, a cyclohexylphenyl group, a chlorophenyl group, a bromophenyl group, a phenylphenyl group, or a benzylphenyl group, 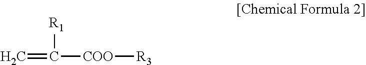
wherein R₁ is H or (CH₂)n-CH₃, wherein n is an integer from 0 to 5; and
R₃ is a substituent represented by the following Chemical Formula 3, 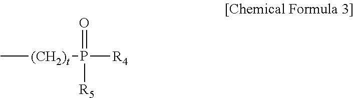
wherein t is an integer from 1 to 10; and
R₄ and R₅ are independently —O(CH₂)qX, wherein q is an integer from 0 to 5 and X includes a methyl group, a cyclohexyl group, a phenyl group, a methylphenyl group, a methylethylphenyl group, a propylphenyl group, a methoxyphenyl group, a cyclohexylphenyl group, a chlorophenyl group, a bromophenyl group, a phenylphenyl group, or a benzylphenyl group.

2. The phosphoric and acrylic copolymer resin of claim 1, wherein (A-2) the phosphoric monomer comprises dimethyl (methacryloyloxymethyl) phosphonate, diethyl (methacryloyloxymethyl) phosphonate, dimethyl (acryloyloxymethyl) phosphonate, diethyl (acryloyloxymethyl) phosphonate, methylethyl (methacryloyloxymethyl) phosphonate, methylethyl (acryloyloxymethyl) phosphonate, dimethyl (methacryloyloxyethyl) phosphonate, diethyl (methacryloyloxyethyl) phosphonate, or dipropyl (methacryloyloxyethyl) phosphonate.

3. The phosphoric and acrylic copolymer resin of claim 1, wherein the phosphoric and acrylic copolymer resin comprises (A-1) about 30 to about 85% by weight of the vinyl monomer and (A-2) about 15 to about 70% by weight of the phosphoric monomer.

4. The phosphoric and acrylic copolymer resin of claim 1, wherein the phosphoric and acrylic copolymer resin has a weight average molecular weight of about 30 to about 150 Kg/mol.

5. The phosphoric and acrylic copolymer resin of claim 1, comprising phosphorous in an amount of about 2.0 to about 7.0% by weight.

6. The phosphoric and acrylic copolymer resin of claim 1, wherein the phosphorus and acrylic copolymer resin has a flame retardancy of V2 to V0 measured in accordance with UL-94 at a thickness of ⅛″.

7. The phosphoric and acrylic copolymer resin of claim 1, wherein the phosphorus and acrylic copolymer resin has a total luminous transmittance of 85% or more measured in accordance with ASTM D1003 at a thickness of 2.5 mm.

8. The phosphoric and acrylic copolymer resin of claim 1, wherein the phosphorus and acrylic copolymer resin has a pencil hardness of HB to 2H measured in accordance with JIS K5401.

9. The phosphoric and acrylic copolymer resin of claim 1, wherein the phosphorus and acrylic copolymer resin is prepared by suspension polymerization.

10. A flameproof acrylic resin composition comprises (A) about 100 parts by weight of the phosphorus and acrylic copolymer resin according to claim 1 and (B) about 1 to about 30 parts by weight of a transparent and soft acrylate resin, wherein (B) the transparent and soft acrylate resin is prepared by grafting a vinyl monomer into an acrylic rubber core.

11. The flameproof acrylic resin composition of claim 10, wherein (B) the transparent and soft acrylate resin has a refractive index of about 1.485 to about 1.495.

12. The flameproof acrylic resin composition of claim 10, wherein the flameproof acrylic resin composition has an unnotched izod impact strength of 20 kgfcm/cm or more measured in accordance with ASTM D256 at a thickness of ¼″.

13. The flameproof acrylic resin composition of claim 10, wherein the flameproof acrylic resin composition further comprises (C) about 1 to about 30 parts by weight of a phosphoric flame retardant.

14. The flameproof acrylic resin composition of claim 13, wherein (C) the phosphoric flame retardant is a compound represented by the following Chemical Formula 4 or Chemical Formula 5 or a combination thereof: 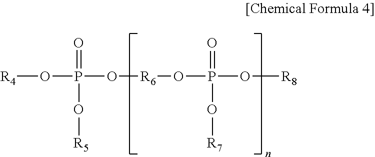
wherein R₄, R₅, R₇ and R₈ are independently C₆-C₂₀ aryl or C₁-C₁₀ alkyl substituted C₆-C₂₀ aryl;
R₆ is a derivative of a dialcohol comprising resorcinol, hydroquinol, bisphenol-A, or bisphenol-S; and
n is an integer from 0 to 10, 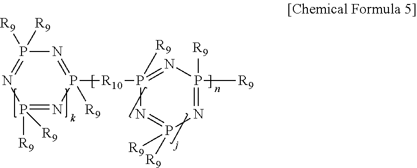
wherein each R₉ is independently C₁-C₁₀ alkyl, C₆-C₂₀ aryl, C₁-C₁₀ alkyl substituted C₆-C₂₀ aryl, C₇-C₂₀ aralkyl, C₁-C₁₀ alkoxy, C₇-C₂₀ aryloxy, amino or hydroxyl;
k and j are independently an integer from 0 to 10; and
n is a number average degree of polymerization, where the average value of n is about 0.3 to about 3.

15. The flameproof acrylic resin composition of claim 13, wherein the flameproof acrylic resin composition has a flame retardancy of V1 to V0 measured in accordance with UL94 at a thickness of ⅛″.
